(19) United States
(12) Patent Application Publication
(10) Pub. No.: US 2026/0212210 A1
(43) Pub. Date: Jul. 23, 2026

(54) ELECTRONIC DEVICE AND CONTROL METHOD OF ELECTRONIC DEVICE

(71) Applicant: SAMSUNG ELECTRONICS CO., LTD., Suwon-si (KR)

(72) Inventors: Minyoung KANG, Suwon-si (KR); Byungsoo OH, Suwon-si (KR); Taegeon UM, Suwon-si (KR)

(73) Assignee: SAMSUNG ELECTRONICS CO., LTD., Suwon-si (KR)

(21) Appl. No.: 19/570,868

(22) Filed: Mar. 18, 2026

Related U.S. Application Data
(63) Continuation of application No. PCT/KR2024/017091, filed on Nov. 1, 2024.

(30) Foreign Application Priority Data
Nov. 28, 2023 (KR) 10-2023-0167703

(51) Int. Cl. G06N 3/098

(52) U.S. Cl. CPC G06N 3/098

(57) ABSTRACT

A device and method for distributed learning are provided. The device obtains resource information for performing distributed learning of a neural network model through a plurality of parallelism methods. A plurality of resource combinations are identified for performing the plurality of parallelism methods, using the resource information. For each of a plurality of layers, first throughput information of the resources is obtained. A stage information is obtained using the first throughput information by partitioning layers included in the neural network model for each of the plurality of resource combination. A second throughput information for the plurality of resource combinations is obtained by performing distributed learning on each of the plurality of resource combinations through the plurality of parallelism methods on the basis of the stage information. An optimal distributed learning strategy is obtained on the basis of the second throughput information for the plurality of resource combinations.

### CROSS-REFERENCE TO RELATED APPLICATIONS

This application is a Continuation Application of International Application PCT/KR2024/017091 filed on Nov. 1, 2024, which claims benefit of Korean Patent Application No. 10-2023-0167703, filed on Nov. 28, 2023, at the Korean Intellectual Property Office, the disclosures of which are incorporated herein in their entireties by reference.

### BACKGROUND

### 1. Field

This disclosure relates to an electronic device and a control method thereof, and more particularly, to an electronic device using a plurality of parallelism methods to perform distributed learning and a control method thereof.

### 2. Background of Related Art

Currently, in the artificial intelligence field, training artificial intelligence models on a large scale may cause consumption of large amounts of resources and costs. Under the circumstances, required is a method by which artificial intelligence models are trained to secure high performance by using a minimum amount of resources and costs.

In particular, to train artificial intelligence models on a large scale, a method of performing distributed learning through a plurality of devices based on a plurality of parallelism methods (e.g., data parallelism, pipeline parallelism, tensor parallelism and the like) has been recently provided. Conventionally, at a time when distributed learning is performed based on the plurality of parallelism methods, resources (e.g., a GPU and the like) included in a plurality of devices are partitioned uniformly to perform distributed learning. However, in the case where distributed learning is performed by partitioning resources uniformly in an environment where the type or number of resources differs with respect to each of the plurality of devices, deterioration of learning performance may be caused. In detail, in the case where the type or number of resources differs with respect to each of the plurality of devices, the resources included in the plurality of devices may be allocated to one group as resources for performing tensor parallelism when the resources are partitioned uniformly. At this time, in the case where the resources included in the plurality of devices are allocated to one group, communication costs may be increased causing deterioration of learning performance while in terms of tensor parallelism, frequent communication among the resources is required.

### SUMMARY

An electronic device for distributed learning of a neural network model based on a plurality of parallelism methods includes a communication interface, memory storing a neural network model including a plurality of layers and at least one instruction, and a processor for controlling the electronic device, and the processor executes the at least one instruction, to obtain information on resources included in a plurality of devices for distributed learning of the neural network model based on a plurality of parallelism methods, wherein the plurality of parallelism methods includes data parallelism, pipeline parallelism, and tensor parallelism, identifies, based on information on resources included in the plurality of devices, a plurality of resource combinations for performing the plurality of parallelism methods, obtains first throughput information of resources included in the plurality of devices with respect to each of the plurality of layers, obtains, based on first throughput information of resources included in the plurality of devices, stage information in which the layers included in the neural network model are partitioned with respect to each of the plurality of resource combinations, performs distributed learning based on the stage information with respect to each of the plurality of resource combinations according to the plurality of parallelism methods to obtain second throughput information on the plurality of resource combinations, and obtains information on an optimal distributed learning strategy based on the second throughput information on the plurality of resource combinations.

The processor may group resources included in each the plurality of devices based on the number of resources included in the plurality of devices, and identify, based on the grouped resources, a plurality of resource combinations for performing distributed learning according to the plurality of parallelism methods.

The processor may obtain a common divisor of the number of resources included in the plurality of devices, group, based on the obtained common divisor, resources included in each of the plurality of devices into resources for performing the tensor parallelism, obtain, based on the obtained common divisor and the number of the devices, information on the number of partitionable resource groups, obtain, based on a divisor with respect to the number of the partitionable resource groups, information on the number of resources for performing the data parallelism and the number of resources for performing the pipeline parallelism, and identify, based on information on resource groups for performing the tensor parallelism, and the number of resources for performing the data parallelism and the number of resources for performing the pipeline parallelism, a plurality of resource combinations for performing the plurality of parallelism methods.

The processor may divide, based on the number of resources included in the plurality of devices, the plurality of devices into a plurality of virtual devices such that the plurality of devices has an identical number of resources, and identify, based on resources included in the plurality of virtual devices, a plurality of resource combinations for performing the plurality of parallelism methods.

The processor may obtain a greatest common divisor of resources included in the plurality of devices, divide, based on the greatest common divisor, virtual devices with respect to each of the plurality of devices to obtain the plurality of virtual devices, obtain a common divisor of resources included in the plurality of virtual devices, obtain, based on the common divisor, information on the number of resources for performing pipeline parallelism, obtain, based on remaining resources excluding resources for performing the pipeline parallelism among resources included in the plurality of virtual devices, information on the number of resources for performing data parallelism and the number of resources for performing tensor parallelism, and identify, based on information on the number of resources for performing the tensor parallelism, the number of resources for performing the data parallelism, and the number of resources for performing the pipeline parallelism, a plurality of resource combinations for performing the plurality parallelism methods.

The processor may perform a profile on the plurality of layers by using resources included in the plurality of devices to obtain first throughput information of resources included in the plurality of devices with respect to each of the plurality of layers, and the first throughput information may include at least one of information on execution time and information on memory consumption.

The processor may obtain, based on first throughput information of resources included in the plurality of devices, stage information in which the layers are partitioned, such that as a result of performing learning by using resources included in the plurality of devices with respect to a plurality of stages obtained by partitioning the layers included in the neural network model, a deviation of execution time for performing the plurality of stages is minimized.

The processor may obtain, based on first throughput information of resources included in the plurality of devices, stage information in which the layers included in the neural network model are partitioned with respect each batch size, perform, based on the stage information obtained with respect to each batch size, distributed learning based on the plurality of parallelism methods with respect to each of the plurality of resource combinations to obtain second throughput information on the plurality of resource combinations, and obtain, based on the second throughput information on the plurality of resource combinations, information on an optimal distributed learning strategy enabling fastest distributed learning.

The optimal distributed learning strategy may include information on an optimal resource combination, an optimal stage and an optimal batch size.

According to one embodiment, a control method of an electronic device for distributed learning of a neural network model based on a plurality of parallelism methods includes obtaining information on resources included in a plurality of devices for distributed learning of the neural network model based on a plurality of parallelism methods, wherein the plurality of parallelism methods includes data parallelism, pipeline parallelism, and tensor parallelism, identifying, based on information on resources included in the plurality of devices, a plurality of resource combinations for performing the plurality of parallelism methods, obtaining first throughput information of resources included in the plurality of devices with respect to each of the plurality of layers, obtaining, based on the first throughput information of resources included in the plurality of devices, stage information in which the layers included in the neural network model are partitioned with respect to each of the plurality of resource combinations, performing distributed learning based on the stage information with respect to each of the plurality of resource combinations according to the plurality of parallelism methods to obtain second throughput information on the plurality of resource combinations, and obtaining information on an optimal distributed learning strategy based on the second throughput information on the plurality of resource combinations.

The identifying may include grouping resources included in each the plurality of devices based on the number of resources included in the plurality of devices, and identifying, based on the grouped resources, a plurality of resource combinations for performing distributed learning according to the plurality of parallelism methods.

The identifying may include obtaining a common divisor of the number of resources included in the plurality of devices, grouping, based on the obtained common divisor, resources included in each of the plurality of devices into resources for performing the tensor parallelism, obtaining, based on the obtained common divisor and the number of the devices, information on the number of partitionable resource groups, obtaining, based on a divisor with respect to the number of the partitionable resource groups, information on the number of resources for performing the data parallelism and the number of resources for performing the pipeline parallelism, and identifying, based on information on resource groups for performing the tensor parallelism, and the number of resources for performing the data parallelism and the number of resources for performing the pipeline parallelism, a plurality of resource combinations for performing the plurality of parallelism methods.

The identifying may include dividing, based on the number of resources included in the plurality of devices, the plurality of devices into a plurality of virtual devices such that the plurality of devices has an identical number of resources, and identifying, based on resources included in the plurality of virtual devices, a plurality of resource combinations for performing the plurality of parallelism methods.

The identifying may include obtaining a greatest common divisor of resources included in the plurality of devices, dividing, based on the greatest common divisor, virtual devices with respect to each of the plurality of devices to obtain the plurality of virtual devices, obtaining a common divisor of resources included in the plurality of virtual devices, obtaining, based on the common divisor, information on the number of resources for performing pipeline parallelism, obtaining, based on remaining resources excluding resources for performing the pipeline parallelism among resources included in the plurality of virtual devices, information on the number of resources for performing data parallelism and the number of resources for performing tensor parallelism, and identifying, based on information on the number of resources for performing the tensor parallelism, the number of resources for performing the data parallelism, and the number of resources for performing the pipeline parallelism, a plurality of resource combinations for performing the plurality parallelism methods.

The obtaining first throughput information may include performing a profile on the plurality of layers by using resources included in the plurality of devices to obtain first throughput information of resources included in the plurality of devices with respect to each of the plurality of layers, and the first throughput information may include at least one of information on execution time and information on memory consumption.

The obtaining stage information may include obtaining, based on first throughput information of resources included in the plurality of devices, stage information in which the layers are partitioned, such that as a result of performing learning by using resources included in the plurality of devices with respect to a plurality of stages obtained by partitioning the layers included in the neural network model, a deviation of execution time for performing the plurality of stages is minimized.

The obtaining stage information may include obtaining, based on first throughput information of resources included in the plurality of devices, stage information in which the layers included in the neural network model are partitioned with respect to each batch size, the obtaining second throughput information may include performing, based on the stage information obtained with respect to each batch size, distributed learning based on the plurality of parallelism methods with respect to each of the plurality of resource combinations to obtain second throughput information on the plurality of resource combinations, and the obtaining information on an optimal distributed learning strategy may include obtaining, based on the second throughput information on the plurality of resource combinations, information on an optimal distributed learning strategy enabling fastest distributed learning.

The optimal distributed learning strategy may include information on an optimal resource combination, an optimal stage and an optimal batch size.

### BRIEF DESCRIPTION OF DRAWINGS

FIG. 1 is a block diagram illustrating a configuration of an electronic device, according to one embodiment;

FIG. 2 is a flowchart provided to explain a control method of an electronic device for distributed learning of a neural network model based on a plurality of parallelism methods, according to one embodiment;

FIGS. 3A-3D are views provided to explain a method of obtaining resource combinations by grouping resources included in a plurality of devices, according to one embodiment;

FIGS. 4A-4D are views provided to explain a method of obtaining resource combinations by identifying a plurality of virtual devices through resources included in a plurality of devices, according to one embodiment;

FIG. 5 is a view provided to explain a method of obtaining optimal stage information for performing pipeline parallelism, according to one embodiment; and

FIG. 6 is a view provided to explain an optimal distributed learning strategy with respect to a neural network model, according to one embodiment.

### DETAILED DESCRIPTION

Embodiments of the disclosure may be modified in various different forms, and may vary. Accordingly, specific embodiments are illustrated in the drawings, and described in the detailed description. However, it is to be understood that the embodiments set forth herein are not intended to limit the scope of the matter of the disclosure and are interpreted as including various modifications, equivalents and/or alternatives thereof. In description of the drawings, like reference numerals may be used to indicate like elements.

In description of the matter of the disclosure, if detailed descriptions of known functions or configurations to which the matter of the disclosure pertains make the gist of the disclosure unnecessarily vague, the descriptions are omitted.

Additionally, the embodiments described hereafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

The terms set forth herein are merely used to describe specific examples, and are not intended to limit the scope of the right for which protection is sought. Unless explicitly stated otherwise, singular forms include plural forms as well.

In the disclosure, expressions such as “have,” “may have,” “include,” or “may include,” and the like are used to indicate the presence of a corresponding feature (e.g., a numerical value, a function, an operation, or an element such as a part and the like), and do not imply the exclusion of the presence of additional features.

In the disclosure, expressions such as “A or B,” “at least one of A or/and B,” or “one or more of A or/and B,” and the like may include all possible combinations of the items listed together. For example, “A or B,” “at least one of A and B,” or “at least one of A or B” may refer to all cases including (1) at least one A, (2) at least one B, or (3) both of at least one A and at least one B.

In the disclosure, expressions such as “1^{st},” “2^{nd},” “first,” or “second,” and the like may be used to refer to various elements regardless of their order and/or importance, and may be merely used to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly or through yet another element (e.g., a third element).

On the other hand, based on one element (e.g., a first element) referred to as being “directly coupled with/to or connected with/to” another element (e.g., a second element), it is to be understood that yet another element (e.g., a third element) is not present between one element and another element.

The expression “configured to (or set to) . . . ” used herein may be used interchangeably with, for example, “suitable for . . . ,” “having the capacity to . . . ,” “designed to . . . ,” “adapted to . . . ,” “made to . . . ,” or “capable of . . . ” depending on circumstances. The term “configured to (or set to) . . . ” may not necessarily mean “specifically designed to . . . ” in a hardware manner.

Instead, in a certain situation, the expression “an device configured to . . . ” may mean “being capable of performing . . . ” by the device together with another device or other elements. For example, the phrase “a processor configured (or set) to perform A, B and C” may mean an exclusive processor (e.g., an embedded processor) for performing corresponding functions, or a generic-purpose processor (e.g., a CPU or an application processor) capable of performing corresponding functions by executing one or more software programs stored in a memory device.

In the embodiments, the term “module” or “unit” may perform at least one function or operation, and be implemented by hardware or software or by a combination of hardware and software. Additionally, multiple “modules” or multiple “units” may be integrated into at least one module and be implemented as at least one processor, excluding a “module” or a “unit” that needs to be implemented by specific hardware.

Meanwhile, various elements and regions in the drawings are schematically illustrated. Accordingly, the technical spirit of the disclosure is not limited by relative sizes or distances illustrated in the drawings.

According to the disclosure, a “neural network model”, as a model implemented based on the neural network of the human brain, may mean entire models in which artificial neurons forming a network based on a synaptic connection have the ability to solve a problem by changing the strength of the synaptic connection via learning. At this time, the neural network model may include a plurality of layers (or layers), and for example, may include an input layer, an output layer and a plurality of hidden layers between the input layer and the output layer. At this time, the neural network model may include an artificial neural network (ANN) model, a deep neural network (DNN) model and the like.

According to the disclosure, “distributed learning”, as a method by which neural network models or data are divided for learning by using a plurality of devices (at this time, the plurality of devices may be referred to as “a plurality of nodes” or “a plurality of machines”), may employ data parallelism or model parallelism broadly. At this time, the model parallelism may include pipeline parallelism and tensor parallelism.

According to the disclosure, “parallelism” is a method by which neural network models are partitioned among a plurality of devices (or a plurality of nodes) or a plurality of resources, to perform distributed learning in parallel. At this time, the parallelism method may include data parallelism, pipeline parallelism and tensor parallelism.

According to the disclosure, “data parallelism” is a technique in which training data are processed in parallel in a neural network model. In other words, data parallelism is a technique in which entire neural network models are allocated to each of the plurality of resources, while entire training data are divided into a certain amount of batches and a certain amount of batches is allocated to each of the resources to train the neural network models.

According to the disclosure, “pipeline parallelism” is a technique in which neural network models are divided based on each layer to be processed in parallel. In other words, pipeline parallelism is a technique in which a plurality of resources included in neural network models are divided into a plurality of stages, while each of the plurality of stages is allocated to the resources to train the neural network models.

According to the disclosure, “tensor parallelism” is a technique in which layers included in neural network models are divided to be processed in parallel. In other words, tensor parallelism is a technique in which a plurality of layers included in neural network models is divided and allocated to a plurality of resources to train the neural network models. Unlike pipeline parallelism, tensor parallelism is a method of allocating one layer to a plurality of resources rather than dividing neural network models based on each of the plurality of layers and requires a sync operation of adding outputs of intermediate layers or final layers.

According to the disclosure, “resource” may include a computing resource for performing various functions such as specific calculations or tasks, and for example, include a processor such as a graphics processing unit (GPU), a neural processing unit (NPU) and the like or hardware such as a core included in the processor, and the like.

Hereafter, the embodiments of the disclosure are described in detail with reference to the accompanying drawings, such that those skilled in the art to which the disclosure pertains can readily implement the embodiments.

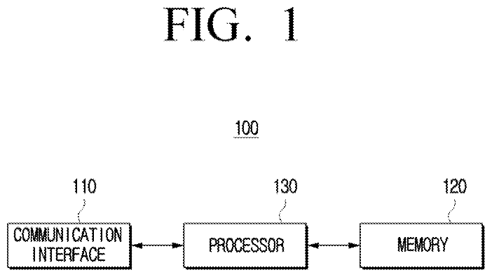

FIG. 1 is a block diagram illustrating a configuration of an electronic device, according to one embodiment. As illustrated in FIG. 1, an electronic device 100 may include a communication interface 110, memory 120, and a processor 130. Meanwhile, the configuration of the electronic device 100 in FIG. 1 is illustrated merely as one embodiment, and certainly, some elements may be added depending on the type of electronic device 100.

The electronic device 100 according to one embodiment may be implemented as a server, but this is described merely as one embodiment, and may be implemented as a user terminal such as a smartphone, a tablet PC, a laptop PC and the like, or various types of devices such as a smart TV, a home appliance, an IoT device and the like. Additionally, in the case where the electronic device 100 is implemented as a server, the electronic device 100 may certainly be implemented as two or more servers.

The communication interface 110 may include circuitry, and perform communication with an external device (a server or a user terminal). In detail, the processor 130 may receive various types of data or information from the external device connected thereto through the communication interface 110, and also transmit various types of data or information to the external device.

The communication interface 110 may include at least one of a WiFi module, a Bluetooth module, a wireless communication module, an NFC module and an ultra-wide band (UWB) module. At this time, the wireless communication module may perform communication according to various communication standards such as IEEE, Zigbee, 3rd Generation (3G), 3rd Generation Partnership Project (3GPP), Long Term Evolution (LTE), 5th Generation (5G) and the like.

In particular, the communication interface 110 may receive information on resources from a plurality of devices for distributed learning of a neural network model based on a plurality of parallelism methods. At this time, the information on resources may include information such as the types of resources, the product names or product numbers of resources, the number of resources and the like.

The memory 120 may store an operating system (OS) for controlling entire operations of the elements of the electronic device 100 and instructions or data associated with the elements of the electronic device 100. In particular, the memory 120 may include various types of modules for performing distributed learning based on a plurality of parallelism methods. In particular, based on a function for performing distributed learning based on the plurality of parallelism methods being executed, the electronic device 100 may load data on various types of modules for performing distributed learning to volatile memory, based on the plurality of parallelism methods stored in non-volatile memory. Herein, the loading procedure may mean an operation of calling the data stored in the non-volatile memory into the volatile memory and storing the data in the volatile memory such that the processor 130 accesses the data.

Additionally, the memory 120 may store information on a neural network model including a plurality of layers. At this time, the neural network model may be a language model capable of processing massive amounts of data such as voice recognition, natural language understanding and the like, but this is described merely as one embodiment, and may be a neural network model capable of performing various operations such as object recognition, translation, document summarization, image generation and the like.

Meanwhile, the memory 120 may be implemented as non-volatile memory (e.g., a hard disk, solid-state drive (SSD), flash memory), volatile memory (also including memory in a processor 120), and the like.

The processor 130 may control the electronic device 100 according to at least one instruction stored in the memory 120.

In particular, the processors 130 may include a plurality of processors. In detail, the plurality of processors may include one or more of a central processing unit (CPU), a graphics processing unit (GPU), an accelerated processing unit (APU), Many Integrated Core (MIC), a digital signal processor (DSP), a neural processing unit (NPU), a hardware accelerator or a machine learning accelerator. The one or more processors may control one among other elements of the electronic device or any combination thereof, and perform an operation associated with communication or data processing. The one or more processors may execute one or more programs or instructions stored in the memory. For example, the plurality of processors may perform a method according to one embodiment, by executing one or more instructions stored in the memory.

In the case where the method according to one embodiment includes a plurality of operations, the plurality of operations may be performed by one processor, or by a plurality of processors. In other words, in the case where a first operation, a second operation, and a third operation are performed based on the method according to one embodiment, the first operation, the second operation and the third operation may all be performed by a first processor, or the first operation and the second operation may be performed by the first processor (e.g., a generic-purpose processor), while the third operation may be performed by a second processor (e.g., an AI-exclusive processor). For example, an operation of identifying an optimal distributed learning strategy may be performed by a first processor (e.g., a CPU), while an operation of distributed learning of a neural network model is performed by a second processor (e.g., a GPU or an NPU).

At least one processor 120 may be also implemented as one or more multicore processors including a plurality of cores (e.g., a homogeneous multi core or a heterogeneous multi core). In the case where the at least one processor 120 is implemented as a multicore processor, each of the plurality of cores included in the multicore processor may include processor internal memory such as cache memory, and on-chip memory, and common cache shared by the plurality of cores may be included in the multicore processor. Additionally, each of the plurality of cores (or part of the plurality of cores) included in the multicore processor may read and perform a program instruction for implementing the method according to one embodiment independently or in the way that all (or part) of the plurality of cores are associated.

In the case where the method according to one embodiment includes a plurality of operations, the plurality of operations may be performed by one of the plurality of cores or performed by the plurality of cores included in the multicore processor. For example, in the case where a first operation, a second operation, and a third operation are performed based on the method according to one embodiment, the first operation, the second operation and the third operation may all be performed by a first core included in the multicore processor, or the first operation and the second operation may be performed by the first core included in the multicore processor, while the third operation may be performed by a second core included in the multicore processor.

In the embodiments, the processor may denote a system on a chip (SoC) where one or more processors and other electronic parts are integrated, a single core processor, a multicore processor, or a core included in a single core processor or a multicore processor, and herein, the core may be implemented as a CPU, a GPU, an APU, an MIC, a DSP an NPU, a hardware accelerator or a machine learning accelerator and the like, but embodiments thereof may not be limited thereto.

Meanwhile, the processor 130 may execute at least one instruction, to obtain information on resources included in a plurality of devices for distributed learning of a neural network model based on a plurality of parallelism methods. Herein, the plurality of parallelism methods includes data parallelism, pipeline parallelism and tensor parallelism. Additionally, the plurality of devices may include an electronic device 100, but this is described merely as one embodiment, and may be implemented as a plurality of external devices including no electronic device 100.

The processor 130 identifies a plurality of resource combinations for performing the plurality of parallelism methods based on the information on resources included in the plurality of devices. At this time, the resource combinations may mean combinations of resources for performing data parallelism, pipeline parallelism and tensor parallelism. For example, in the case where a total of eight resources is included in the plurality of devices, resource combinations are (1, 1, 8), (1, 2, 4), (1, 4, 2), (1, 8, 1), (2, 1, 4), (2, 2, 2), (2, 4, 1), (4, 2, 1), (4, 1, 2), (8, 1, 1). At this time, in (x, y, z), x may mean the number (or size) of resources for performing pipeline parallelism, y may mean the number (or size) of resources for performing data parallelism, and z may mean the number (or size) of resources for performing tensor parallelism. Herein, performing parallelism may mean performing distributed learning based on a parallelism method.

The processor 130 obtains first throughput information of resources included in the plurality of devices with respect to each of the plurality of layers. At this time, the first throughput information, is information associated with a speed of processing one layer included in a neural network model at a time when learning of the neural network model is performed by using the resources, may include at least one of information on execution time for processing one layer, information on an amount of data stored in the memory 120 based on the operation of processing one layer, and the like.

The processor 130 obtains information on a stage of partitioning layers included in the neural network model with respect to each of the plurality of resource combinations based on the first throughput information of the resources included in the plurality of devices. At this time, the stage may mean a group of layers in which layers included in a neural network model are divided to perform pipeline parallelism. For example, in the case where ten layers are included in a neural network model and are divided into two groups of five to perform pipeline parallelism, first-fifth layers may be referred to as a first stage, while sixth-tenth layers may be referred to as a second stage.

The processor 130 performs, based on the stage information, distributed learning based on the plurality of parallelism methods with respect to each of the plurality of resource combinations to obtain second throughput information on the plurality of resource combinations. The second throughput information, as information associated with a speed of learning of a neural network model at a time when learning of the neural network model is performed based on the resource combinations, may include at least one of information on execution time for learning of the neural network model per one iteration, information on an amount of data stored in the memory 120 based on an operation of learning of the neural network model, and the like.

The processor 130 obtains information on an optimal distributed learning strategy based on the second throughput information on the plurality of resource combinations. At this time, the optimal distributed learning strategy may include information on an optimal resource combination, an optimal stage, an optimal batch size enabling the most excellent (or fastest) learning ability at a time of distributing learning of a neural network model.

As one embodiment, the processor 130 may group resources included in each of the plurality of devices based on the number of resources included in the plurality of devices, and identify, based on the grouped resources, a plurality of resource combinations for performing distributed learning through a plurality of parallelism methods. In detail, the processor 130 may obtain a common divisor of the number of resources included in the plurality of devices. The processor 130 may group, based on the obtained common divisor, the resources included in each of the plurality of devices into resources for performing tensor parallelism. The processor 130 may obtain information on the number of partitionable resource groups based on the obtained common divisor and the number of devices. The processor 130 may obtain, based on a divisor with respect to the number of partitionable resource groups, information on the number of resources for performing data parallelism and information on the number of resources for performing pipeline parallelism. The processor 130 may identify the plurality of resource combinations for performing the plurality of parallelism methods based on information on a resource group for performing tensor parallelism, the number of resources for performing data parallelism, and the number of resources for performing pipeline parallelism.

As one embodiment, the processor 130 may divide the plurality of devices into a plurality of virtual devices such that the plurality of devices has an identical number of resources based on the number of resources included in the plurality of devices, and identify the plurality of resource combinations for performing the plurality of parallelism methods based on resources included in the plurality of virtual devices. In detail, the processor 130 may obtain a greatest common divisor of resources included in the plurality of devices. The processor 130 may divide the virtual devices based on the greatest common divisor with respect to each of the plurality of devices to obtain the plurality of virtual devices. The processor 130 may obtain a common divisor of resources included in the plurality of virtual devices. The processor 130 may obtain information on the number of resources for performing pipeline parallelism based on the common divisor. The processor 130 may obtain, based on remaining resources excluding resources for performing pipeline parallelism among the resources included in the plurality of virtual devices, information on the number of resources for performing data parallelism and information on the number of resources for performing tensor parallelism. The processor 130 may identify the plurality of resource combinations for performing the plurality of parallelism methods based on the information on the number of resources for performing tensor parallelism, the number of resources for performing data parallelism, and the number of resources for performing pipeline parallelism.

As one embodiment, the processor 130 may perform a profile on a plurality of layers by using the resources included in the plurality of devices to obtain first throughput information of resources included in the plurality of devices with respect to each of the plurality of layers. At this time, the profile means an operation of measuring the performance of a layer by using specific resources. At this time, the first throughput information may include at least one of information on execution time and information on memory consumption.

As one embodiment, the processor 130 may obtain, based on first throughput information of resources included in the plurality of devices, stage information in which the layers are partitioned, such that as a result of performing learning by using resources included in the plurality of devices with respect to a plurality of stages obtained by partitioning the layers included in the neural network model, a deviation of execution time for performing the plurality of stages is minimized.

As one embodiment, the processor 130 may obtain stage information in which the layers included in the neural network model are partitioned with respect to each batch size based on the first throughput information of resources included in the plurality of devices. At this time, the batch size means the number of data samples that are input to the neural network model at a time to train the neural network model. The processor 130 may perform, based on the stage information obtained with respect to each batch size, distributed learning with respect to each of the plurality of resource combinations through the plurality of parallelism methods to obtain second throughput information on the plurality of resource combinations. The processor 130 may obtain, based on the second throughput information with respect to the plurality of resource combinations, information on an optimal distributed learning strategy enabling the fastest distributed learning.

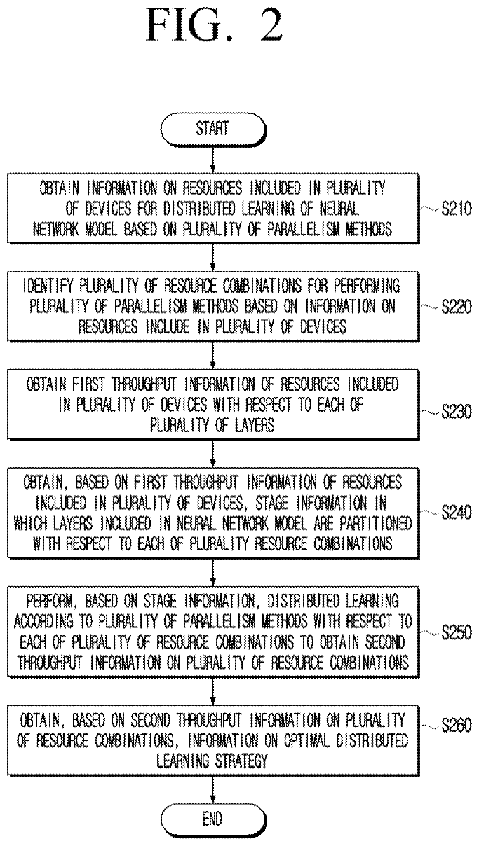

Hereafter, the subject matter of the disclosure is described in greater detail with reference to FIGS. 2-6.

FIG. 2 is a flowchart provided to explain a control method of an electronic device for distributed learning of a neural network model based on a plurality of parallelism methods, according to one embodiment.

First, an electronic device 100 obtains information on resources included in a plurality of devices for distributed learning of a neural network model based on a plurality of parallelism methods (S210). Herein, the plurality of parallelism methods may include data parallelism, pipeline parallelism and tensor parallelism.

As one embodiment, the electronic device 100 may receive the information on resources included in the plurality of devices from each of the plurality of devices. At this time, the information on resources may include the types of resources included in the plurality of devices (e.g., a GPU, a NPU, a CPU and the like), product information of resources (e.g., a product name, a product number and the like), the number of resources and the like. As one embodiment, the electronic device 100 may obtain the information on resources included in the plurality of devices based on a user input.

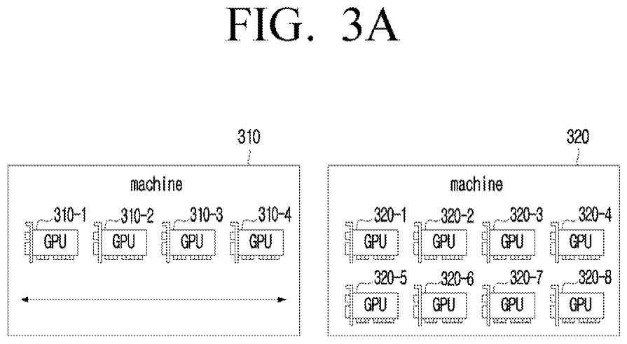

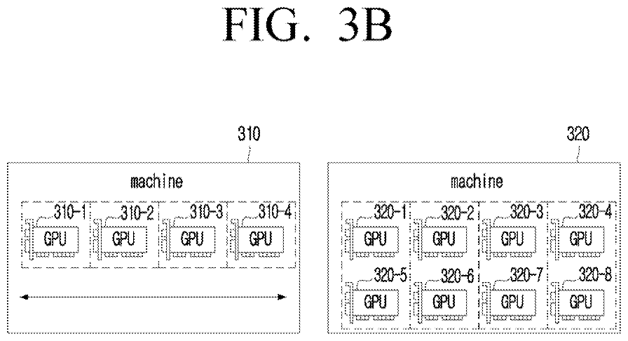

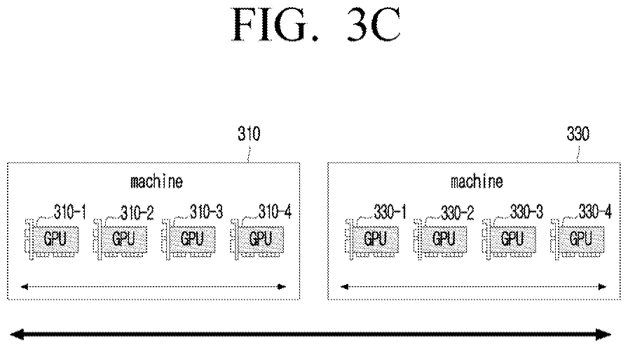

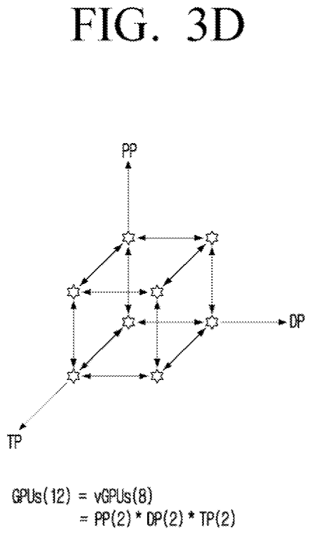

The electronic device 100 identifies a plurality of resource combinations for performing the plurality of parallelism methods based on the information on resources included in the plurality of devices (S220). In detail an identical number of resources are allocated and evenly disposed regardless of resources included in the plurality of devices. For example, in the case where an equivalent partitioning method is used under the situation where a first device 310 includes four resources 310-1 to 310-4 while a second device 320 includes eight resources 320-1 to 320-8 as illustrated in FIG. 3A, resources of another device may be included in a group for performing one tensor parallelism based on a resource combination of three or six resources for performing tensor parallelism being generated among a plurality of resource combinations. Since frequent communication among resources is required as described above in the case of tensor parallelism, frequent communication may result in deterioration of performance in the case where resources included in devices different from each other are included in a group for one tensor parallelism.

Accordingly, in the disclosure, a method described hereafter may be used to generate a resource combination such that resources included in devices different from each other is not included in a group for one tensor parallelism.

As one embodiment, the electronic device 100 may group, based on the number of resources included in the plurality of devices, the resources included in each of the plurality of devices, and identify, based on the grouped resources, a plurality of resource combinations for performing distributed learning according to a plurality of parallelism methods. Hereafter, the subject matter of the disclosure is described in greater detail with reference to FIGS. 3A-3D.

In detail, the electronic device 100 may obtain a common divisor of the number of resources included in the plurality of devices. For example, in the case where the first electronic device 310 includes four resources 310-1 to 310-4 while the second device 320 includes eight resources 320-1 to 320-8 as illustrated in FIG. 3A, the electronic device 100 may obtain 4 that is the common divisor of the number of resources included in the plurality of devices 310, 320. Additionally, the electronic device 100 may group the resources included in each of the plurality of devices based on the obtained common divisor into resources for performing tensor parallelism. For example, the electronic device 100 may group the resources included in the plurality of devices 310, 320 such that one device has groups in number corresponding to 4 that is the common divisor, as illustrated in FIG. 3B. In other words, the electronic device 100 may group each of the 1-1 to 1-4 resources 310-1 to 310-4 included in the first device 310 as one group, and group the 2-1 to 2-8 resources 320-1 to 320-8 included in the second device 320 into four groups of two. In the case where the grouping is performed as described above, the electronic device 100, as illustrated in FIG. 3C, may group the resources included in the first device 310 as four groups 310-1 to 310-4, and divide the resources included in the second device 310 into four groups 330-1 to 330-4. Accordingly, since the electronic device 100 may obtain information on the two devices including four resource groups under the situation where the two devices have 12 resources, to obtain a search space enabling equivalent partition illustrated in FIG. 3D.

As another example, in the case where the first device 310 includes fours resources 310-1 to 310-4, while the second device 320 includes eight resources 320-1 to 320-8 as illustrated in FIG. 3A, the electronic device 100 may obtain 1 or 2 that is a common divisor of the number of resources included in the plurality of devices 310, 320. The electronic device 100 may group the resources included in the plurality of devices 310, 320 such that one device has groups in number corresponding to 2 that is the common divisor. In other words, the electronic device 100 may divide the 1-1 to 1-4 resources 310-1 to 310-4 included in the first device 310 into two groups of two, and divide the 2-1 to 2-8 resources 320-1 to 320-8 included in the second device 320 are divided into two groups of four. As yet another example, the electronic device 100 may group the resources included in the plurality of devices 310, 320 such that one device has groups in number corresponding to 1 that is the common divisor. In other words, the electronic device 100 may divide the 1-1 to 1-4 resources 310-1 to 310-4 included in the first device 310 into one group of four, and divide the 2-1 to 2-8 resources 320-1 to 320-8 included in the second device 320 into one group of eight.

Additionally, the electronic device 100 may obtain information on the number of resource groups partitionable based on the obtained common divisor and the number of devices. At this time, the number of partitionable resource groups may be obtained by multiplying the common divisor and the number of devices. For example, in the case where the common divisor is four, the number of partitionable resource groups may be eight that is calculated by multiplying the common divisor and the number of devices. As another example, in the case where the common divisor is two, the number of partitionable resource groups may be four that is calculated by multiplying the common divisor and the number of devices. As yet another example, in the case where the common divisor is one, the number of partitionable resource groups may be two that is calculated by multiplying the common divisor and the number of devices.

The electronic device 100 may obtain information on the number of resources for performing data parallelism and the number of resources for performing pipeline parallelism, based on a divisor of the number of partitionable resource groups. For example, in the case where the number of partitionable resource groups is 8, a divisor of the number of partitionable resource groups is [1, 2, 4, 8], the electronic device 100 may obtain (1, 8), (2, 4), (4, 2), (8, 1) as combinations of the number of resources for performing data parallelism and the number of resources for performing pipeline parallelism. As another example, in the case where the number of partitionable resource groups is four, a divisor of the number of partitionable resource groups is [1, 2, 4], the electronic device 100 may obtain (1, 4), (2, 2), (4, 1) as combinations of the number of resources for performing data parallelism and the number of resources for performing pipeline parallelism. As yet another example, in the case where the number of partitionable resource groups is two, a divisor of the number of partitionable resource groups is [1, 2], the electronic device 100 may obtain (1, 2), (2, 1) as combinations of the number of resources for performing data parallelism and the number of resources for performing pipeline parallelism.

The electronic device 100 may identify a plurality of resource combinations for performing a plurality of parallelism methods based on information on resource groups for performing tensor parallelism, the number of resources for performing data parallelism, and the number of resources for performing pipeline parallelism. As one embodiment, the electronic device 100 may obtain resource combinations as shown hereafter in Table 1.

TABLE 1

- Resource number of first device: 4
- Resource number of second device: 8
- Common divisor of resources included
in first device and second device:
[1,2,4]
- Resource combination (PP_size, DP_size, TP_group)
(1, 8, TP_group(4)) herein, TP_group(4) indicates 1, 2
(2, 4, TP_group(4)) herein, TP_group(4) indicates 1, 2
(4, 2, TP_group(4)) herein, TP_group(4) indicates 1, 2
(8, 1, TP_group(4)) herein, TP_group(4) indicates 1, 2
(1, 4, TP_group(2)) herein, TP_group(4) indicates 2, 4
(2, 2, TP_group(2)) herein, TP_group(2) indicates 2, 4
(4, 1, TP_group(2)) herein, TP_group(2) indicates 2, 4
(2, 1, TP_group(1)) herein, TP_group(1) indicates 4, 8
(1, 2, TP_group(1)) herein, TP_group(1) indicates 4, 8

In Table 1 suggested above, PP_size may mean the number of resources for performing pipeline parallelism, DP_size may mean the number of resources for performing data parallelism, and TP_group may mean resource groups for performing tensor parallelism, and TP_group(4) may mean that one or two resources of each of a first device 100 and a second device 200 are used, TP_group(2) may mean that 2 or 4 resources of each of the first device 100 and the second device 200 are used, and TP_group(1) may mean that four or eight resources of each of the first device 100 and the second device 200 are used. In the case where resources included in a plurality of devices are grouped to uniformize the number of the resources included in the plurality of devices in the same way as shown in the above table, resources included in devices different from each other may be prevented from being included to perform tensor parallelism.

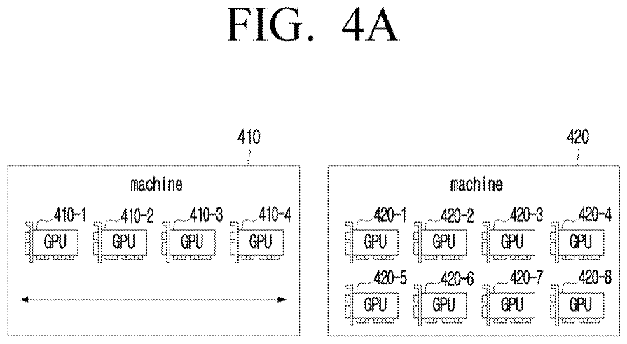

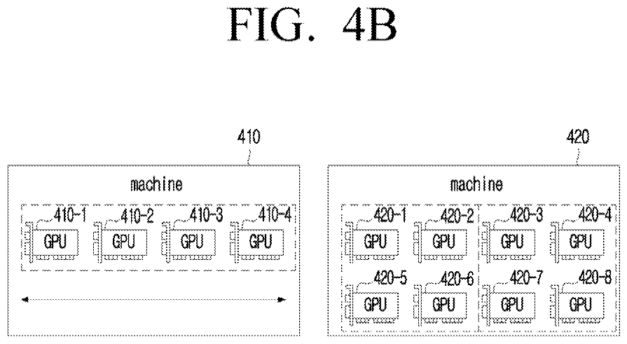

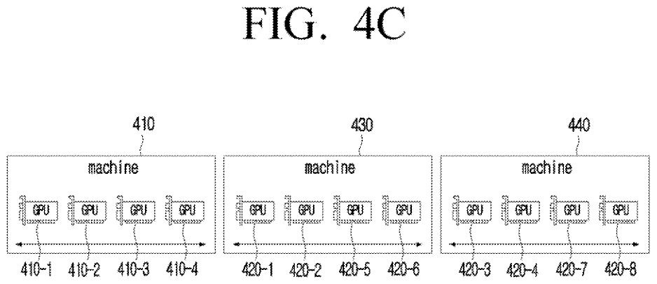

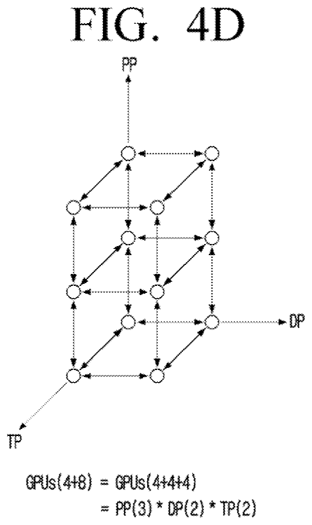

As one embodiment, the electronic device 100 may divide the plurality of devices into a plurality of virtual devices such that the plurality of devices has an identical number of resources based on the number of the resources included in the plurality of devices, and identify a plurality of resource combinations for performing a plurality of parallelism methods based on resources included in the plurality of virtual devices. Hereafter, the subject matter of the disclosure is described in greater detail with reference to FIGS. 4A-4D. Meanwhile, for the embodiment to be applied, the number of resources included in an device having a minimum number of resources among the plurality of devices may be a divisor of the number of resources of the other devices.

The electronic device 100 may obtain a greatest common divisor of the resources included in the plurality of devices. For example, in the case where a first device 410 includes four resources 410-1 to 410-4, while a second device 420 includes eight resources 420-1 to 420-8 as illustrated in FIG. 4A, the electronic device 100 may obtain 4 that is the greatest common divisor of the number of the resources included in the plurality of devices 310, 320.

Additionally, the electronic device 100 may divide the virtual devices with respect to each of the plurality of devices based on the greatest common divisor to obtain the plurality of virtual devices. For example, since the greatest common divisor is 4 under the situation where the first device 410 includes four resources 410-1 to 410-4 while the second device 420 includes eight resources 420-1 to 420-8 as illustrated in FIG. 4A, the electronic device 100, as illustrated in FIG. 4B, may divide the resources of the plurality of devices 410, 420 such that the plurality of devices 410, 420 has resources in number corresponding to the greatest common divisor. In other words, the electronic device 100, as illustrated in FIG. 4B, may obtain one virtual device such that the first device 410 has four resources, and divide the second device 420 into two virtual devices such that the two virtual devices have four resources. Accordingly, the electronic device 100, as illustrated in FIG. 4C, may obtain a first virtual device 410 having four resources 410-1 to 410-4, a second virtual device 430 having four resources 420-1, 420-2, 420-5, 420-6, and a third virtual device 440 having four resources 420-3, 420-4, 420-7, 420-8. Meanwhile, the embodiment in which the second device 420 is divided into two virtual devices may not be limited to that of FIG. 4C, and the second device 420 may be divided into two virtual devices in various combinations. For example, the second virtual device 430 may include four resources 420-1 to 420-4, and the third virtual device 440 may include four resources 420-5 to 420-8. By doing so, since the electronic device 100 may obtain information on the three virtual devices that include four resources respectively under the situation where the two devices have 12 resources, the electronic device 100 may obtain a search space enabling equivalent partition as illustrated in FIG. 4D.

Additionally, the electronic device 100 may obtain a common divisor of the resources included in the plurality of virtual devices. For example, since 12 resources are included in the plurality of virtual devices, the electronic device 100 may obtain [1, 2, 3, 4, 6, 12] as divisors of the resources included in the plurality of virtual devices.

Additionally, the electronic device 100 may obtain information on the number of resources for performing pipeline parallelism based on the common divisor. In other words, the electronic device 100 may determine 1, 2, 3, 4, 6, 12 as the resources for performing pipeline parallelism.

Additionally, the electronic device 100 may obtain information on the number of resources for performing data parallelism and the number of resources for performing tensor parallelism based on remaining resources excluding the resources for performing pipeline parallelism among the resources included in the plurality of virtual devices. At this time, the case where the number of resources for performing tensor parallelism exceeds the number (i.e., four) of the resources included in the virtual devices may be excluded.

For example, in the case where the number of a resource for performing pipeline parallelism is one, the number of remaining resources is 12, and since the number of resources for performing tensor parallelism cannot exceed 4, the electronic device 100 may obtain (3, 4), (4, 3), (6, 2), (12, 1) as the number of resources for performing data parallelism and the number of resources for performing tensor parallelism. Additionally, in the case where the number of resources for performing pipeline parallelism is two, the number of remaining resources is six, and since the number of resources for performing tensor parallelism cannot exceed 4, the electronic device 100 may obtain (2, 3), (3, 2), (6, 1) as the number of resources for performing data parallelism and the number of resources for performing tensor parallelism. In the case where the number of resources for performing pipeline parallelism is three, the number of remaining resources is 4, and since the number of resources for performing tensor parallelism cannot exceed 4, the electronic device 100 may obtain (1, 4), (2, 2), (4, 1) as the number of resources for performing data parallelism and the number of resources for performing tensor parallelism. In the case where the number of resources for performing pipeline parallelism is four, since the number of remaining resources is three, the electronic device 100 may obtain (1, 3), (3, 1) as the number of resources for performing data parallelism and the number of resources for performing tensor parallelism. In the case where the number of resources for performing pipeline parallelism is six, since the number of remaining resources is two, the electronic device 100 may obtain (2, 1), (2, 1) as the number of resources for performing data parallelism and the number of resources for performing tensor parallelism. In the case where the number of resources for performing pipeline parallelism is 12, since the number of a remaining resource is 1, the electronic device 100 may obtain (1, 1) as the number of resources for performing data parallelism and the number of resources for performing tensor parallelism.

Additionally, the electronic device 100 may identify a plurality of resource combinations for performing a plurality of parallelism methods based on information on the number of resources for performing tensor parallelism, the number of resources for performing data parallelism and the number of resources for performing pipeline parallelism. As one embodiment, the electronic device 100 may obtain resource combination as shown hereafter in Table 2.

TABLE 2

- Resource number of first device: 4
- Resource number of second device: 8
- Greatest common divisor of resources
included in first device and second
device: 4
- Resource combination (PP_size, DP_size, TP_size)
(1, 3, 4)
(1, 4, 3)
(1, 6, 2)
(1, 12, 1)
(2, 2, 3)
(2, 3, 2)
(2, 6, 1)
(3, 1, 4)
(3, 2, 2)
(3, 4, 1)
(4, 3, 1)
(4, 1, 3)
(6, 2, 1)
(6, 1, 2)
(12, 1, 1)

In Table 2 suggested above, PP_size may mean the number of resources for performing pipeline parallelism, DP_size may mean the number of resources for performing data parallelism, and TP_size may mean the number of resources for performing tensor parallelism. In the case where a plurality of devices is divided into a plurality of virtual devices such that the plurality of virtual devices has an identical number of resources, and the number of the resources included in the plurality of virtual devices is uniformized in the same way as shown in the above table, resources included in devices different from each other may be prevented from being included to perform tensor parallelism.

In other words, the electronic device 100 may obtain information on at least one of nine resource combinations included in Table 1, and 15 resource combinations included in Table 2 through S220.

Referring back to FIG. 2, the electronic device 100 obtains first throughput information of resources included in a plurality of devices with respect to each of a plurality of layers (S230). In detail, the electronic device 100 may perform a profile on the plurality of layers by using the resources included in the plurality of devices to obtain the first throughput information of the resources included in the plurality of devices with respect to each of the plurality of layers. For example, as illustrated in FIG. 3A, in the case where a first type of resources (e.g., a GPU having first performance) included in a first device 310, and a second type of resources (a GPU having second performance; at this time, the second performance may be excellent than the first performance.) included in a second device 320 are used for distributed learning of a neural network model having a total of 12 layers, the electronic device 100 may obtain information on execution time and memory consumption for each of the layers processed after data are input to each of the total of 12 layers by using the first type of resources, and obtain information on execution time and memory consumption for each of the layers processed after data are input to each of the total of 12 layers by using the second type of resources. By doing so, the electronic device 100 may obtain the first throughput information of the resources included in the plurality of devices with respect to each of the plurality of layers.

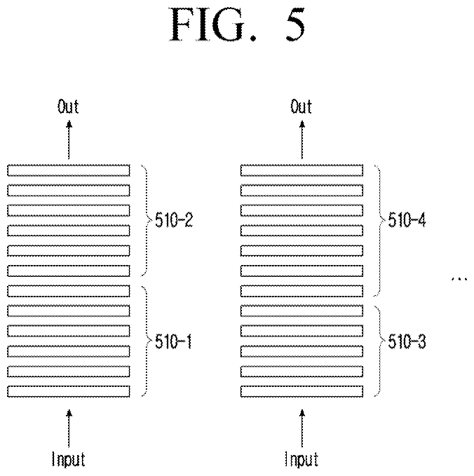

The electronic device 100 obtains, based on the first throughput information of the resources included in the plurality of devices, stage information in which the layers included in the neural network model with respect to each of a plurality of resource combinations are partitioned (S240). At this time, the electronic device 100 may obtain stage information in which the layers are partitioned such that a deviation of execution time for performing a plurality of stages is minimized, as a result of performance of learning with resources included in the plurality of devices with respect to the plurality of stages obtained by partitioning the layers included in the neural network model. For example, as illustrated on the left of FIG. 5 in the case of distributed learning of the neural network model including the 12 layers, the electronic device 100 may divide the layers into a group of six to obtain a first stage 510-1 and a second stage 510-2. The electronic device 100 may obtain, based on the first throughput information, first execution time spent as a result of performing learning of the first stage 510-1 by using first resources among a plurality of resources and second execution time spent as a result of performing learning of the second stage 510-2 by using second resources among the plurality of resources. Additionally, the electronic device 100 may identify a first deviation of the first execution time and the second executing time. Additionally, as illustrated on the right of FIG. 5 with respect to the same neural network model, the electronic device 100 may divide the layers into a group of five and a group of seven to obtain a third stage 510-3 and a fourth stage 510-4. The electronic device 100 may obtain, based on the first throughput information, third execution time spent as a result of performing learning of the third stage 510-3 by using first resources among a plurality of resources and fourth execution time spent as a result of performing learning of the fourth stage 510-4 by using second resources among the plurality of resources. Additionally, the electronic device 100 may identify a second deviation of the third execution time and the fourth executing time. The electronic device 100, as described above, may divide the plurality of layers included in the neural network model based on a plurality of methods to obtain information on a plurality of stage combinations, and obtain deviations of execution time spent as a result of learning the stage combinations. Additionally, the electronic device 100 may obtain stage information in which the layers are partitioned to correspond to a stage combination of which a deviation of executing time is minimized among the plurality of stage combinations. For example, if the deviation of execution time is small in the case of division into the third stage 510-3 combination and the fourth stage 510-4 combination, as illustrated on the right of FIG. 5, the electronic device 100 may obtain a combination of the third stage 510-3 and the fourth stage 510-4 as stage information corresponding to a first resource combination, among a plurality of resource combinations, in which the number of resources for performing pipeline parallelism is two.

The electronic device 100 may repeat performing S240 with respect to the plurality of resource combinations obtained in S220 to obtain stage information with respect to each of the plurality of resource combinations. For example, the electronic device 100 may obtain stage information in the case where the number of resources for performing pipeline parallelism is two and stage information in the case where the number of resources for performing pipeline parallelism is four. At this time, the electronic device 100 may obtain no stage information in the case where the number of a resource for performing pipeline parallelism is one since the layers are not need to be divided.

Meanwhile, when performing S240, the electronic device 100 may obtain stage information in which the layers included in the neural network model are partitioned based on each batch size. In detail, the first throughput information may include information on spent time and memory consumption based on each batch size. Accordingly, the electronic device 100 may use the first throughput information to obtain stage information in which the layers included in the neural network model are partitioned based on each batch size with respect to the plurality of resource combinations.

The electronic device 100 may perform, according to the stage information, distributed learning based on a plurality of parallelism methods with respect to each of the plurality of resource combinations to obtain second throughput information with respect to each of the plurality of resource combinations (S250). In other words, based on distributed learning being performed according to the plurality of resource combinations obtained in S220 and the stage information obtained in S240, the electronic device 100 may obtain the second throughput information with respect to each of the plurality of resource combinations.

At this time, the electronic device 100 may perform distributed learning based on the plurality of parallelism methods with respect to each of the plurality of resource combinations according to the stage information obtained based on each batch size to obtain the second throughput information with respect to each of the plurality of resource combinations. In other words, the electronic device 100 may obtain second throughput information according to stage information based on each of a plurality of batch sizes with respect to each of the plurality of resource combinations. For example, the electronic device 100 may obtain the second throughput information based on stage information obtained in the case of a first batch size with respect to each of the plurality of resource combinations, and obtain the second throughput information based on stage information obtained in the case of a second batch size with respect to each of the plurality of resource combinations.

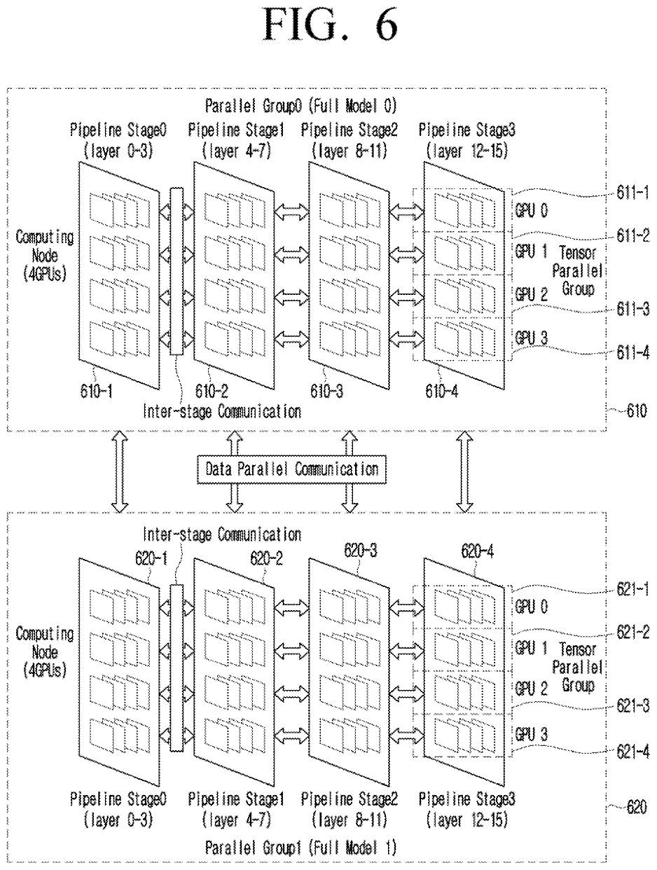

The electronic device 100 may obtain information on an optimal distributed learning strategy based on the second throughput information with respect to the plurality of resource combinations. In other words, the electronic device 100 may obtain information on an optimal distributed learning strategy enabling fastest distributed learning based on the second throughput information with respect to each of the plurality of resource combinations obtained in S250. At this time, the optimal distributed learning strategy may include information on an optimal resource combination, an optimal stage and an optimal batch size. For example, in the case of distributed learning of a neural network model with a plurality of devices including a total of 16 resources, the electronic device 100, as illustrated in FIG. 6, may identify resource combinations including four resources for performing pipeline parallelism, two resources for performing data parallelism, and four resources for performing tensor parallelism among the plurality of resource combinations. In detail, the electronic device 100, as illustrated in FIG. 6, may identify resources for training a first neural network model 610 and a second neural network model 620 as resources for performing data parallelism. Additionally, the electronic device 100 may identify resources for learning four stages 610-1-610-4 included in the first neural network model 610 and four stages 610-1-610-4 included in the second neural network model 620 as resources for performing pipeline parallelism. Further, the electronic device 100 may identify resources for learning four tensors 611-1-611-4 included in one stage of the first neural network model 610 and four tensors 621-1-621-4 included in one stage of the second neural network model 620 as resources for performing tensor parallelism.

Furthermore, the electronic device 100 may configure a batch size considering execution time predicted based on each pipeline to process a maximum number of samples per hour in entire pipelines. Accordingly, the electronic device 100 may obtain information on an optimal distributed learning strategy including information an optimal batch size input to each neural network model.

An artificial intelligence (AI)-relating function according to the disclosure may be performed through the processor and the memory of the electronic device 100.

The processor may be comprised of one processor or a plurality of processors. At this time, the one processor or the plurality of processors include at least one of a central processing unit (CPU), a graphic processing unit (GPU), a neural processing unit (NPU), but not be limited to the above example thereof.

The CPU, as a generic-purpose processor capable of performing an AI computation as well as a normal computation, may efficiently execute a complex program through a multi-level cache structure. The CPU is advantageous in a series processing method enabling an organic connection between previous calculation results and following calculation results based on a consecutive calculation. The generic-purpose processor is not limited to the above example, unless explicitly indicated as the above-described CPU.

The GPU, as a processor for a massive computation such as a floating-point computation and the like used to process graphics, may perform a massive computation in parallel by integrating cores in massive amounts. In particular, the GPU may have an advantage over the CPU in a parallel processing method such as a convolution computation and the like. Additionally, the GPU may be used as a co-processor for complementing a function of the CPU. A processor for a massive computation is not limited to the above example, unless explicitly indicated as the above-described GPU.

The NPU, as a processor specializing in an AI computation using an artificial neural network, may be implemented in the way that each layer constituting an artificial neural network is implemented with hardware (e.g., silicon). At this time, since the NPU is designed specially according to specifications required by a business, a flexibility of the NPU is less than that of the CPU or the GPU, but the NPU may process an AI computation required by a business efficiently. Meanwhile, as a processor specializing in an AI computation, the NPU may be implemented in various different forms such as a tensor processing unit (TPU), an intelligence processing unit (IPU), a vision processing unit (VPU) and the like. An AI processor is not limited to the above examples, unless explicitly indicated as the above-described NPU.

Additionally, the one processor or the plurality of processors may be implemented as a system on a chip (SoC). At this time, memory, and a network interface such as a bus and the like for data communication between the processor and the memory may be further included, in addition to the one processor or the plurality of processors, in the SoC.

In the case where a plurality of processors is included in a system on a chip (SoC) included in the electronic device 100, the electronic device 100 may perform an AI-relating computation (e.g., a computation associated with learning or inference of an AI model) by using part of the plurality of processors. For example, the electronic device 100 may perform an AI-relating computation by using at least one of a GPU, an NPU, a VPU, a TPU, and a hardware accelerator specializing in an AI computation such as a convolution computation, a matrix multiplication computation and the like, among the plurality of processors. However, this is described merely as one embodiment, and certainly, an AI-relating computation may be processed by using the CPU and the like and a generic-purpose processor.

Additionally, the electronic device 100 may perform a computation associated with an AI-relating function by using a multi core (e.g., a dual core, a quad core and the like) included in one processor. In particular, the electronic device 100 may perform an AI computation such as a convolution computation, a matrix multiplication computation and the like in parallel by using a multi core included in the processor.

The one processor or the plurality of processors may perform control to process input data, according to a predefined operation rule or an AI model that is stored in the memory. The predefined operation rule or the AI model is characterized in that the predefined operation rule or the AI model is made based on learning.

Herein, making the predefined operation rule or the AI model based on learning means making a predefined operation rule or an AI model of a desired feature, by applying a learning algorithm to large numbers of learning data. Such learning may be performed in an device itself in which AI according to the disclosure is performed, or performed through a separate server/system.

The AI model may be comprised of a plurality of neural network layers. At least one layer has at least one weight value, and a computation of layers is performed through results of a computation of a previous layer and at least one defined computation. Examples of the neural network may include a convolutional neural network (CNN), a deep neural network (DNN), a recurrent neural network (RNN), a restricted boltzmann machine (RBM), a deep belief network (DBN), a bidirectional recurrent deep neural network (BRDNN), and a deep Q-network, and a transformer, but the neural network in the disclosure is not limited to the above examples, unless explicitly stated otherwise.

The learning algorithm is a method that trains a predetermined object device (e.g., a robot) by using a large number of learning data, enabling the predetermined object device to make its own decision or prediction. Examples of the learning algorithm may include supervised learning, unsupervised learning, semi-supervised learning or reinforcement learning, but the learning algorithm in the disclosure is not limited to the above examples, unless explicitly stated otherwise.

The method according to the embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)), or distributed (e.g., downloaded or uploaded) online through an application store (e.g., Play Store™) or directly between two user devices (e.g., smartphones). In the case of online distribution, at least part of the computer program product (e.g., a downloadable app) may be stored at least temporarily, or generated temporarily in a machine-readable storage medium such as a manufacturer's server, a server of an application store, or memory of a relay server.

The method according to the embodiments set forth herein may be implemented with software including instructions stored in a storage medium readable by a machine (e.g., a computer). The machine, as an device capable of calling the stored instructions from the storage media and operating according to the called instructions, may include the electronic device (e.g., a TV) according to the disclosed embodiments.

Meanwhile, the machine-readable storage medium may be provided in the form of a non-transitory storage medium. Herein, the “non-transitory storage medium” only means a tangible device and means including no signal (e.g., electromagnetic waves) while the term does not distinguish semi-permanent or temporary storage of data in the storage medium. For example, the “non-transitory storage medium” may include a buffer where data are temporarily stored.

Based on the above-described instructions executed by a processor, the processor may perform functions corresponding to the instructions directly or by using other elements under the control of the processor. The instructions may include a code generated or executed by a compiler or an interpreter.

While the example embodiments of the disclosure are illustrated and described above, embodiments of the disclosure are not limited to the embodiments set forth herein, and certainly, various modifications thereof may be made by those skilled in the art to which the disclosure pertains, without departing from the scope of the subject matter of the disclosure claimed in the section of claims, and are not to be understood as separating from the technical spirit or prospect of the disclosure.

What is claimed:

1. An electronic device for distributed learning of a neural network model using a plurality of parallelism methods, the electronic device comprising:
a communication interface;
memory storing a neural network model including a plurality of layers and at least one instruction; and
a processor for controlling the electronic device, wherein the processor executes the at least one instruction cause the device to:
obtain information on at least one resource included in a plurality of devices for distributed learning of the neural network model using the plurality of parallelism methods, the plurality of parallelism methods including data parallelism, pipeline parallelism, and tensor parallelism,
identify, based on information on the at least one resource included in the plurality of devices, a plurality of resource combinations for performing the plurality of parallelism methods,
obtain a first throughput information of the at least one resource included in the plurality of devices with respect to each of the plurality of layers,
obtain, based on the first throughput information of the at least one resource included in the plurality of devices, a stage information in which the plurality layers are partitioned with respect to each of the plurality of resource combinations,
perform distributed learning based on the stage information with respect to each of the plurality of resource combinations according to the plurality of parallelism methods to obtain a second throughput information on the plurality of resource combinations, and
obtain at least one information on an optimal distributed learning strategy based on the second throughput information of the plurality of resource combinations.

2. The electronic device of claim 1,
wherein the processor further executes the at least one instruction to cause the device to:
group the at least one resource included in the plurality of devices based on a number of the at least one resource included in the plurality of devices, and
identify, based on the grouped at least one resource, a plurality of resource combinations for performing distributed learning according to the plurality of parallelism methods.

3. The electronic device of claim 2,
wherein the processor further executes the at least one instruction to cause the device to:
obtain a common divisor of the number of the at least one resource included in the plurality of devices,
group, based on the obtained common divisor, the at least one resource into at least one resource group for performing the tensor parallelism,
obtain, based on the obtained common divisor and a number of the devices of the plurality of devices, at least one information on a number of partitionable resource groups,
obtain, based on a divisor with respect to the number of the partitionable resource groups, at least one information on a number of the at least one resource for performing the data parallelism and a number of the at least one resource for performing the pipeline parallelism, and
identify, based on an information on the at least one resource group for performing the tensor parallelism, and the number of resources for performing the data parallelism and the number of resources for performing the pipeline parallelism, a plurality of resource combinations for performing the plurality of parallelism methods.

4. The electronic device of claim 1,
wherein the processor further executes the at least one instruction to cause the device to:
divide, based on a number of the at least one resource included in the plurality of devices, the plurality of devices into a plurality of virtual devices such that each device in the plurality of devices has an identical number of resources of the at least one resource, and
identify, based on the at least one resource included in the plurality of virtual devices, a plurality of resource combinations for performing the plurality of parallelism methods.

5. The electronic device of claim 4,
wherein the processor further executes the at least one instruction to cause the device to:
obtain a greatest common divisor of the at least one resource included in the plurality of devices,
divide, based on the greatest common divisor, each virtual device in each of the plurality of devices to obtain the plurality of virtual devices,
obtain a common divisor of the at least one resource included in the plurality of virtual devices,
obtain, based on the common divisor of the at least one resource, an information on a number of resources for performing pipeline parallelism,
obtain, based on at least one remaining resource, an information on a number of resources for performing data parallelism and a number of resources for performing tensor parallelism, wherein the at least one remaining resource excludes each of the at least one resource for performing the pipeline parallelism among resources included in the plurality of virtual devices, and
identify, based on information on the number of resources for performing the tensor parallelism, the number of resources for performing the data parallelism, and the number of resources for performing the pipeline parallelism, a plurality of resource combinations for performing the plurality parallelism methods.

6. The electronic device of claim 1,
wherein the processor further executes the at least one instruction to cause the device to:
perform a profile on the plurality of layers by using the at least one resource included in the plurality of devices to obtain the first throughput information of the at least one resource included in the plurality of devices with respect to each of the plurality of layers, and
the first throughput information includes at least one of information on execution time and information on memory consumption.

7. The electronic device of claim 6,
wherein the processor further executes the at least one instruction to cause the device to:
obtain, based on the first throughput information of the at least one resource included in the plurality of devices, the stage information in which the layers are partitioned, such that as a result of performing learning by using the at least one resource included in the plurality of devices with respect to a plurality of stages obtained by partitioning the layers included in the neural network model, a deviation of execution time for performing the plurality of stages is minimized.

8. The electronic device of claim 1,
wherein the processor further executes the at least one instruction to cause the device to:
obtain, based on the first throughput information of the at least one resource included in the plurality of devices, a stage information in which the plurality of layers included in the neural network model are partitioned with respect to at least one batch size,
perform, based on the stage information obtained with respect to the at least one batch size, distributed learning based on the plurality of parallelism methods with respect to each of the plurality of resource combinations to obtain the second throughput information on the plurality of resource combinations, and
obtain, based on the second throughput information on the plurality of resource combinations, an information on an optimal distributed learning strategy.

9. The electronic device of claim 1,
wherein the optimal distributed learning strategy includes information on an optimal resource combination, an optimal stage and an optimal batch size.

10. A control method of an electronic device for distributed learning of a neural network model having a plurality of layers based on a plurality of parallelism methods, the method comprising:
obtaining at least one information on at least one resource included in a plurality of devices for distributed learning of the neural network model based on a plurality of parallelism methods, the plurality of parallelism methods including data parallelism, pipeline parallelism, and tensor parallelism,
identifying, based on the at least one information on the at least one resource included in the plurality of devices, a plurality of resource combinations for performing the plurality of parallelism methods,
obtaining a first throughput information of the at least one resource included in the plurality of devices with respect to the plurality of layers,
obtaining, based on the first throughput information of the at least one resource included in the plurality of devices, a stage information in which the plurality of layers are partitioned with respect to each of the plurality of resource combinations,
performing distributed learning based on the stage information with respect to each of the plurality of resource combinations according to the plurality of parallelism methods to obtain a second throughput information on the plurality of resource combinations, and
obtaining an information on an optimal distributed learning strategy based on the second throughput information of the plurality of resource combinations.

11. The method of claim 10,
wherein the identifying includes grouping the at least one resource in each of the plurality of devices based on a number of resources included in the plurality of devices, and
identifying, based on the grouped at least one resource, a plurality of resource combinations for performing distributed learning according to the plurality of parallelism methods.

12. The method of claim 11,
wherein the identifying includes obtaining a common divisor of the number of the at least one resource included in the plurality of devices,
grouping, based on the obtained common divisor, the at least one resource into at least one resource group for performing the tensor parallelism,
obtaining, based on the obtained common divisor and a number of the devices, information on a number of partitionable resource groups,
obtaining, based on a divisor with respect to the number of the partitionable resource groups, at least one information on a number of resources for performing the data parallelism and a number of resources for performing the pipeline parallelism, and
identifying, based on an information on the at least one resource group for performing the tensor parallelism, and the number of resources for performing the data parallelism and the number of resources for performing the pipeline parallelism, a plurality of resource combinations for performing the plurality of parallelism methods.

13. The method of claim 10,
wherein the identifying includes dividing, based on the number of the at least one resource included in the plurality of devices, the plurality of devices into a plurality of virtual devices such that each device in the plurality of devices has an identical number of resources of the at least one resource, and
identifying, based on the at least one resource included in the plurality of virtual devices, a plurality of resource combinations for performing the plurality of parallelism methods.

14. The method of claim 13,
wherein the identifying includes obtaining a greatest common divisor of the at least one resource included in the plurality of devices,
dividing, based on the greatest common divisor, each virtual device in each of the plurality of devices to obtain the plurality of virtual devices,
obtaining a common divisor of the at least one resource included in the plurality of virtual devices,
obtaining, based on the common divisor of the at least one resource, an information on a number of resources for performing pipeline parallelism,
obtaining, based on at least one remaining resource, an information on a number of resources for performing data parallelism and a number of resources for performing tensor parallelism, wherein the at least one remaining resource excludes each of the at least resource for performing the pipeline parallelism among resources included in the plurality of virtual devices, and
identifying, based on information on the number of resources for performing the tensor parallelism, the number of resources for performing the data parallelism, and the number of resources for performing the pipeline parallelism, a plurality of resource combinations for performing the plurality parallelism methods.

15. The method of claim 10,
the obtaining first throughput information includes performing a profile on the plurality of layers by using the at least one resource included in the plurality of devices to obtain the first throughput information of the at least one resource included in the plurality of devices with respect to each of the plurality of layers, and
the first throughput information includes at least one of information on execution time and information on memory consumption.
